(19) United States
(12) Patent Application Publication
(10) Pub. No.: US 2014/0086178 A1
(43) Pub. Date: Mar. 27, 2014

(54) Buffer-Aware Packet Scheduling for Downlink Multiuser Systems

(71) Applicant: NEC Laboratories America, Inc., Princeton, NJ (US)

(72) Inventors: Sampath Rangarajan, Bridgewater, NJ (US); Guosen Yue, Plainsboro, NJ (US); Yufeng Wang, Poway, CA (US)

(73) Assignee: NEC Laboratories America, Inc., Princeton, NJ (US)

(21) Appl. No.: 14/040,005

(22) Filed: Sep. 27, 2013

Related U.S. Application Data
(60) Provisional application No. 61/706,471, filed on Sep. 27, 2012.

(51) Int. Cl. H04W 72/12

(52) U.S. Cl. CPC H04W 72/12
USPC 370/329

(57) ABSTRACT

An inventive duffer aware adaptive BAA scheduler considers both channel and buffer conditions to make scheduling decisions. Specifically, channel conditions are used to select candidate users, i.e., only the users whose transmission rates satisfy a certain condition are considered as candidate users. It guarantees a maximum of throughput deduction. Then the buffer conditions are used to make scheduling decisions among all the candidate users, i.e., the user with largest queue backlog among candidate users will be scheduled, to provide improved delay performance.

This application claims the benefit of U.S. Provisional Application No. 61/706,471 entitled “Buffer-Aware Packet Scheduling for Downlink Multiuser Systems”, filed Sep. 27, 2012, of which the contents are incorporated herein by reference.

### BACKGROUND OF THE INVENTION

The present invention relates generally to multiuser wireless systems and, more particularly, to a buffer-aware packet scheduling for downlink multiuser systems.

The maximum throughput (MT) scheduler and Proportional fair (PF) scheduler are extensively adopted in the current wireless systems, with focus on throughput performance. Although MT and PF algorithms can be directly applied to the finite-buffer traffic model, the MT and PF scheduling algorithms are actually buffer-unaware, the delay performance might not be good as the buffer status is not considered in the scheduling algorithms. With growing demands for higher throughput, lower delay and more reliable communication, a better scheduling method should be buffer-aware and satisfy both throughput and delay requirements, while maintaining the reliable and stable communications.

Previous work on buffer-aware scheduling algorithms to reduce the packet delay includes LCQ [1] and ‘d-algorithm’ [2]. [1] represents the publication: M. Neely, “Order Optimal Delay for Opportunistic Scheduling in Multi-User Wireless Uplinks and Downlinks,” IEEE/ACM Trans. Networking, vol. 16, no. 5, pp. 1188-1199, October 2008. [2] represents the publication: M. Sharif and B. Hassibi, “Delay considerations for opportunistic scheduling in broadcast fading channels,” IEEE Trans. Wireless Commun., vol. 6, no. 9, pp. 3353-3363, September 2007. See FIGS. 7 and 8 depicting aspects of LCQ [1] and ‘d-algorithm’ [2], respectively.

In the publication [1], the authors proposed a Longest Connected Queue (LCQ) policy to reduce the average packet delay. LCQ schedules the user with the largest product of channel state and queue backlog. This policy reduces the packet delay, however, it requires more restrictive “balanced” throughput region and is less adaptive, in the sense that users with large queue backlog, but very low channel state may still be scheduled.

In the publication [2], the authors proposed a ‘d-algorithm’ to significantly reduce the worst case delay. The ‘d-algorithm’ schedules the user with largest buffer size among ‘d.’ best candidate users, in terms of their channel condition. This algorithm achieves improved worst-case delay and fairness, however, the algorithm is less stable and less adaptive, in the sense that with a fixed value of d, there is no guarantee or bounds on throughput deduction.

Accordingly, there is a need for buffer-aware packet scheduling for downlink multiuser systems that improves upon prior techniques.

### BRIEF SUMMARY OF THE INVENTION

In an aspect of the present invention, a computer implemented method for buffer aware adaptive packet scheduling in a multiuser wireless system includes employing a scheduler for scheduling packets in a multiuser wireless system that is responsive to both channel and buffer conditions in the multiuser wireless system, the scheduler capable of being generalized with existing metrics such as user rate or weighted rate; using channel conditions to select candidate users which are those users whose transmission rates satisfy a certain condition for attaining a maximum of throughput deduction; and using buffer conditions for scheduling decisions among all the candidate users and the users with largest queue backlog among the candidate users being scheduled to provide improved performance.

In a similar aspect of the present invention, a computer system for buffer aware adaptive packet scheduling in a multiuser wireless system includes employing a scheduler for scheduling packets in a multiuser wireless system that is responsive to both channel and buffer conditions in the multiuser wireless system, the scheduler capable of being generalized with existing metrics such as user rate or weighted rate; using channel conditions to select candidate users which are those users whose transmission rates satisfy a certain condition for attaining a maximum of throughput deduction; and using buffer conditions for scheduling decisions among all the candidate users and the users with largest queue backlog among the candidate users being scheduled to provide improved performance.

These and other advantages of the invention will be apparent to those of ordinary skill in the art by reference to the following detailed description and the accompanying drawings.

### BRIEF DESCRIPTION OF THE DRAWINGS

FIG. 1 is a diagram illustrating an queuing model for downlink multiuser system with a finite buffer traffic model, in accordance with the invention;

FIG. 2 is diagram for the inventive buffer aware adaptive BAA scheduling method, in accordance with the invention;

FIG. 3 is a diagram illustrating the inventive BAA scheduling with an example, in accordance with the invention

FIG. 4 is a diagram of a 2-step implementation of a generalized BAA scheduling method, in accordance with the invention

FIG. 5 is a diagram illustrating examples based on the generalized BAA method of FIG. 4;

FIG. 6 is a diagram showing an exemplary computer to perform the inventive battery life management; and

FIG. 7 is a diagram depicting an aspect from the prior art publication: M. Neely, “Order Optimal Delay for Opportunistic Scheduling in Multi-User Wireless Uplinks and Downlinks,” IEEE/ACM Trans. Networking, vol. 16, no. 5, pp. 1188-1199, October 2008; and

FIG. 8 is a diagram depicting an aspect from the prior art publication: M. Sharif and B. Hassibi, “Delay considerations for opportunistic scheduling in broadcast fading channels,” IEEE Trans. Wireless Commun., vol. 6, no. 9, pp. 3353-3363, September 2007.

### DETAILED DESCRIPTION

This invention considers the design of a scheduling algorithm focusing on improving the system performance by reducing the packet delay, while maintaining the queue stability condition of the networks. There is described herein a new buffer-aware scheduling method, termed as buffer-aware adaptive (BAA) scheduler.

The inventive BAA scheduler considers both channel and buffer conditions to make scheduling decisions. Specifically, channel conditions are used to select candidate users, i.e., only the users whose transmission rates satisfy a certain condition are considered as candidate users. It guarantees a maximum of throughput deduction. Then the buffer conditions are used to make scheduling decisions among all the candidate users, i.e., the user with largest queue backlog among candidate users will be scheduled, to provide improved delay performance.

The inventive BAA scheduler is able to improve the system performances in terms of average packet delay, with a reasonable and constraint throughput reduction. The proposed scheduling method can be easily implemented due to less complexity. Furthermore, it can be generalized with any practical metrics that were used in the current systems, i.e., user rate (MT metric) or weighted rate (PF metric).

There is considered a downlink wireless system with one base station and n users. Due to different the channel conditions, the information or the transmission rates for the n users are different. Denote Rᵢ(t) as the transmission rate for the user i at the time slot t supported by its channel condition.

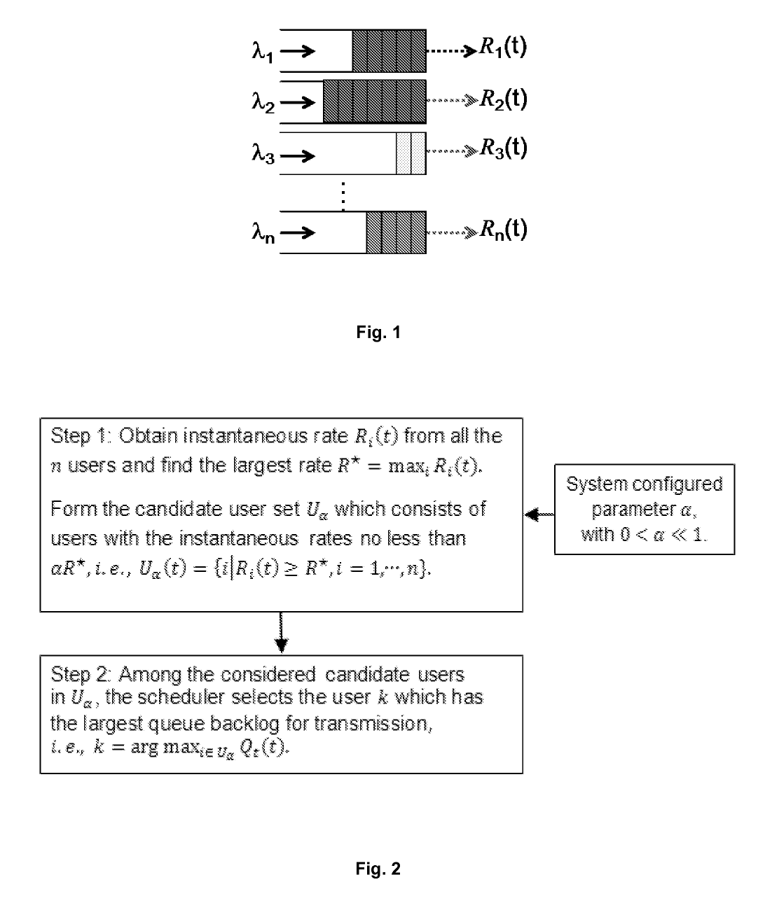

We consider the finite buffer traffic model in which the data packet arrives to the user according a certain distribution with average arrival rate λᵢ. i=1, . . . , n. The queuing model for such a downlink system with finite buffer traffic is illustrated in FIG. 1. The scheduler is to select a user to transmit based on all users' channel condition and the queue status, e.g. backlog size which is the number of information bits or number of packets to be transmitted in the user's buffer.

Basically, the BAA scheduling algorithm consists of two steps. In the first step, a candidate user set is formed, based on either user rate (MT metric) or weighted rate (PF metric) supported by its channel condition. In the second step, a user with the largest queue backlog is selected from the candidate user set.

The BAA scheduling algorithm with MT metric is described in FIG. 2.
1) In first step, the maximum rate of user rate is obtained as R*. With a system configured α, we find all the users with the instantaneous rate Rᵢ(t)≧αR* and form the candidate user set [symbol] _{α}.
2) From the user set [symbol] _{α}, we select the one with the largest queue backlog size to transmit.

More specifically, turning to FIG. 2 again, the two 2-step implementation of the metric-buffer aware adaptive MT-BAA procedure, in accordance with the invention. At each time slot t: Step 1: Obtain instantaneous rate Rᵢ(t) from all the n users and find the largest rate R*=maxᵢRᵢ(t). Form the candidate user [symbol] _{α} which consists of users with the instantaneous rates no less than αR*, i.e., [symbol] _{α}(t)={i|Ri(t)≧R*, i=1, . . . , n}. It is noted that the system is configured with the parameter α, with 0<α<<1. Step 2: Among considered candidate users in [symbol] _{α}, the scheduler selects the user k which has the largest queue backlog for transmission, i.e., k=arg max_{iεUα}Qₜ(t).

Basically, the BAA scheduling algorithm consists of two steps. In the first step, a candidate user set is formed, based on either user rate (MT metric) or weighted rate (PF metric) supported by its channel condition. In the second step, a user with the largest queue backlog is selected from the candidate user set.

The BAA scheduling algorithm with MT metric is described in FIG. 2.
1) In first step, the maximum rate of user rate is obtained as R*. With a system configured α, we find all the users with the instantaneous rate Rᵢ(t)≧αR* and form the candidate user set [symbol] _{α}.
2) From the user set [symbol] _{α}, we select the one with the largest queue backlog size to transmit.

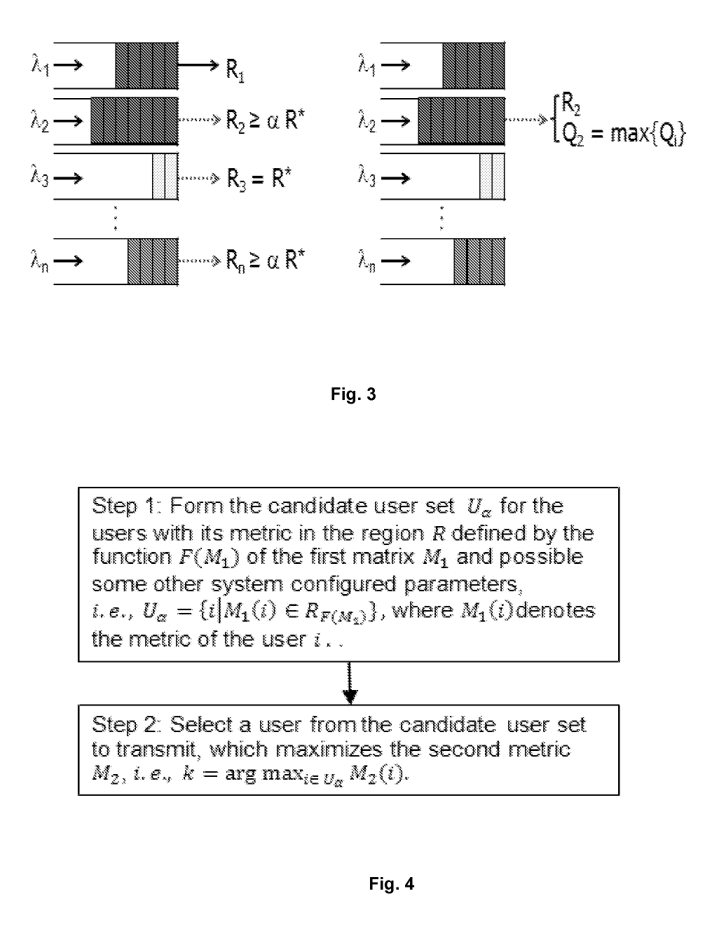

An example is shown in FIG. 3. As shown in the left portion of the figure, the maximum rate is R₃ (t). Compared with the maximum rate, the candidate users 2 to n are selected, whose rates are greater than αR*. Then in the second step shown in the right, user 2 is selected to transmit as its buffer backlog is largest.

It can be seen that the invention is an improvement over d-algorithm, but with a certain flexibility and adaptability. With appropriate setting of α, the potential throughput reduction over MT algorithm is bounded. For instance, with α=0.9, there is a maximum 10% throughput reduction which in turn allows for more flexibility on choosing candidate nodes. Moreover when α=1, the inventive BAA behaves the same as a MT scheduler, i.e., the user with best channel condition is scheduled for transmission. Note that since in the first step of the proposed algorithm, the candidate user set [symbol] _{α} is formed based on the maximum rate, we call it MT-BAA algorithm. It is noted that the BAA scheduling algorithm is also compatible with the PF metric {Rᵢ(t)/uᵢ}, which we call as PF-BAA algorithm.

The inventive BAA technique can be applied to the wideband, e.g., orthogonal frequency division multiplexing (OFDM), systems. For the multiuser systems, we consider OFDMA, i.e., each resource block or subchannel in the frequency domain is assigned to one user exclusively. We assume that there are B resource blocks or subchannels. Denote [symbol] ᵢ as the set of subchannels allocated to user i. The BAA scheduling in the OFDMA or MIMO-OFDMA can be implemented as follows.

For each time slot t
Initializations: [symbol] ᵢ=Ø.
For the subchannel b=1, . . . , B
   Given the rate for subchannel b, R_{i,b}(t), i=1, . . . , n, b=1, . . . , B, and queue backlog Qᵢ(t), apply the BAA (MT-BAA or PF-BAA) scheduling algorithm to determine the user to be scheduled on subchannel n. Assuming that the scheduled user is k, update [symbol] ₖ= [symbol] ₖ∪{b}
For user i=1, . . . , n, transmit data for user i along its allocated subchannels in [symbol] ᵢ.

Furthermore, the inventive scheduling method can be generalized with any two reasonable metrics for these two steps, i.e., forming the candidate user set with one metric and scheduling a user from the candidate user set using another metric. Denote the M₁ and M₂ as the metric in the first and second steps, respectively, which can be a function of rate, average rate, queue backlog, etc. The generalized BAA scheduling scheme can be summarized as shown in FIG. 4. In step 1: Form the candidate user set U_{α} for the users with its metric in the region R defined by the function F(M1) of the first matrix M1 and possibly some other system configured parameters, i.e., U_{α}={i|M₁(i)εR_{F(M}_{₁}₎, where M₁(i) denotes the metric of the user. Step 2: Select a user from the candidate user set to transmit, which maximizes the second metric M₂, i.e., k=arg max_{iεUa}M₂(i).

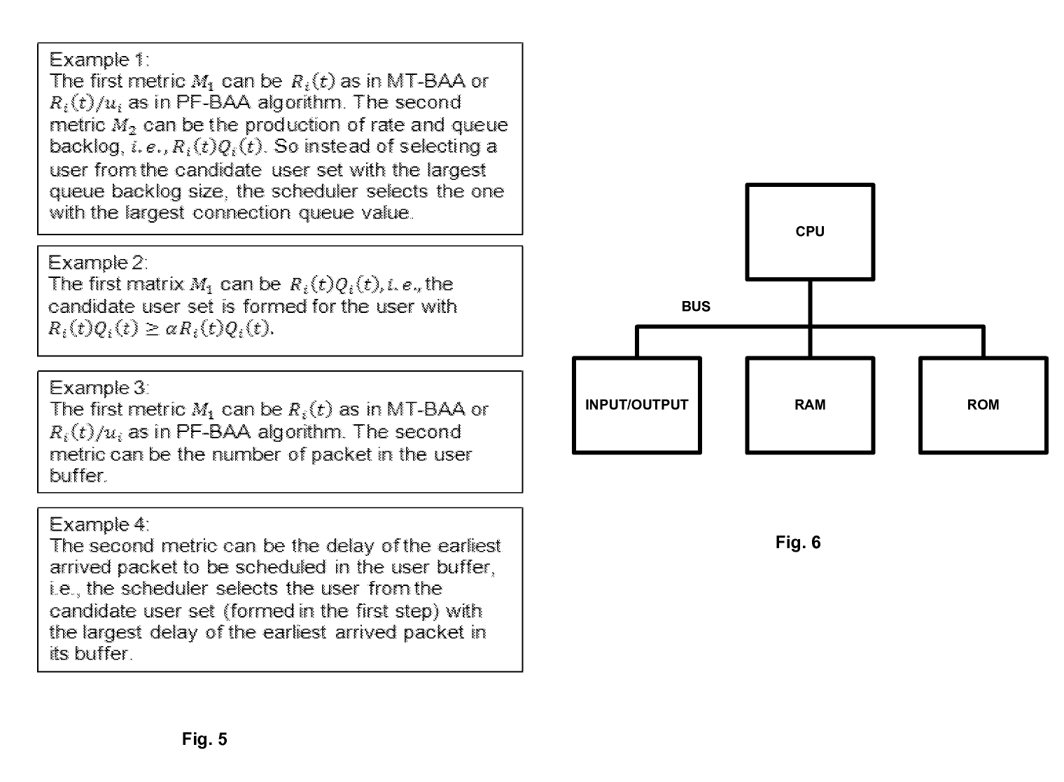

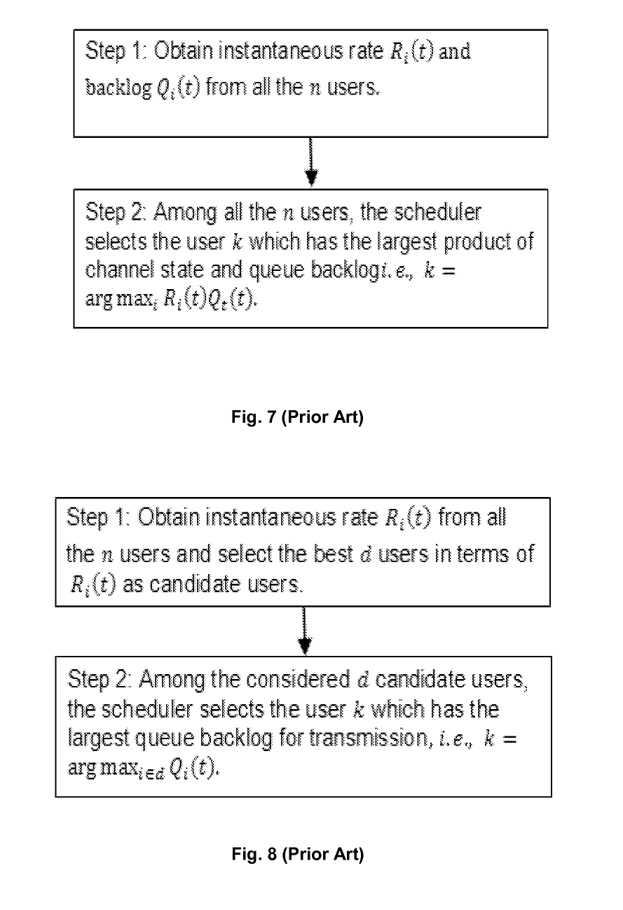

It is noteworthy to point out that with the generalized BAA scheduling method, one can apply any reasonable metrics to this generalized scheme to form one specific scheduling algorithm. Some examples are given in FIG. 5.

In Example 1: The first metric M₁ can be Rᵢ(t) as in MT-BAA or Rᵢ(t)/uᵢ as in PF-BAA procedure. The second metric M₂ can be the production of rate and queue backlog, i.e., Rᵢ(t)Qᵢ(t). So instead of selecting a user from the candidate user set with the largest queue backlog size, the scheduler selects the one with the largest queue value.

In Example 2: The first metric M₁ can be Rᵢ(t)Qᵢ(t), i.e., the candidate user set is formed for the user with Rᵢ(t)Qᵢ(t)≧αRᵢ(t)Qᵢ(t).

In Example 3: the first metric can be Rᵢ(t) as in MT-BAA or Rᵢ(t)/uᵢ as in PF-BAA procedure. The second metric can be the number of packets in the user buffer.

In Example 4: The second metric can be the delay of the earliest arrived packet to be scheduled in the user buffer, i.e., the scheduler selects the user from the candidate user set (formed in the first step) with the largest delay of the earliest arrived packet in its buffer.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next in FIG. 6. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in one of or combination of analog or digital form over one or a number of communication links such as a serial link, local area network, wireless link, optical link and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

From the foregoing it can also be appreciated that the inventive that the inventive scheduling achieves the following competitive values: (1). It is easily implemented due to less complexity, i.e., it only requires extra information on user's backlog size; (2). Fast operation by directly calculations of transmission rate and backlog comparisons; (3). It significantly improves the system performance in terms of packet delay, with only slight and constraint loss on throughput; (4). It is compatible with the metrics used in the current systems, i.e., user rate (MT metric) or weighted rate (PF metric). The common used MT and PF schedulers are special cases (5). It can be generalized with any practical metrics

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. Additional details for this application are provided in the Appendix to the Application. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A computer implemented method for buffer aware adaptive packet scheduling in a multiuser wireless system, the computer implemented method comprising the steps of:
employing a scheduler for scheduling packets in a multiuser wireless system that is responsive to both channel and buffer conditions in the multiuser wireless system, the scheduler capable of being generalized with existing metrics such as user rate or weighted rate;
using channel conditions to select candidate users which are those users whose transmission rates satisfy a certain condition for attaining a maximum of throughput deduction; and
using buffer conditions for scheduling decisions among all the candidate users and the users with largest queue backlog among the candidate users being scheduled to provide improved performance.

2. The computer implemented method of claim 1, wherein the scheduler comprises a buffer aware adaptive BAA scheduler including, first step where a candidate user set is formed, based on either a user rate (MT metric) or a weighted rate (PF metric) supported by its channel condition, and in a second step a user with a largest queue backlog is selected from the candidate user set.

3. The computer implemented method of claim 1, wherein the scheduler comprises a BAA scheduling procedure with a user rate (MT) metric comprising:
i) obtaining as R* a maximum rate of user rate with a system configured parameter a to find all the users with an instantaneous rate Rᵢ(t)≧αR* and form a candidate user set [symbol] _{α}; and
ii) from the user set [symbol] _{α}, selecting a user with a largest queue backlog size to transmit.

4. The computer implemented method of claim 1, wherein the scheduler comprises a buffer aware adaptive scheduler for an orthogonal frequency division multiplexing system implemented as follows:
for each time slot t
Initializations, [symbol] ᵢ=Ø;
for the subchannel b=1, . . . , B;
given the rate for subchannel b, R_{i,b}(t), i=1, . . . , n, b=1, . . . , B, and queue backlog Qᵢ(t), apply the BAA (MT-BAA or PF-BAA) scheduling procedure to determine the user to be scheduled on subchannel n and assuming that the scheduled user is k, update [symbol] ₖ= [symbol] ₖ∪{b};
for user i=1, . . . , n, transmit data for user i along its allocated subchannels in [symbol] ᵢ.

5. The computer implemented of claim 1, wherein the scheduler comprises a generalized buffer aware adaptive scheduler comprising:
i) forming a candidate user set U_{α} for users with its metric in a region R defined by a function F(M1) of a first matrix M1, and possibly some other system configured parameters, i.e., U_{α}={i|M₁(i)εR_{F(M}_{₁}₎, where M₁(i) denotes the metric of the user; and
ii) selecting a user from the candidate user set to transmit that which maximizes a second metric M₂, i.e., k=arg max_{iεUα}M₂(i).

6. The computer implemented method of claim 1, wherein the scheduler comprises a generalized 2-step scheduler procedure with two metrics such as forming a candidate user set with one metric and scheduling a user from the candidate user set using another metric, denoting M₁ and M₂ as a metric in first and second steps respectively, said metrics being a function of one of a function rate, average rate, queue backlog.

7. The computer implemented method of claim 6, wherein the first metric M₁ can be Rᵢ(t) as in MT-BAA or Rᵢ(t)/uᵢ as in PF-BAA procedure and the second metric M₂ can be the production of rate and queue backlog, i.e., Rᵢ(t)Qᵢ(t) and instead of selecting a user from the candidate user set with the largest queue backlog size, the scheduler selects the one with the largest queue value.

8. The computer implemented of claim 6, wherein the first metric M₁ can be Rᵢ(t)Qᵢ(t), i.e., the candidate user set being formed for the user with Rᵢ(t)Qᵢ(t)≧αRᵢ(t)Qᵢ(t).

9. The computer implemented method of claim 6, wherein the second metric can be a delay of the earliest arrived packet to be scheduled in the user buffer, i.e., the scheduler selects the user from the candidate user set formed in the first step with the largest delay of the earliest arrived packet in its buffer.

10. A computer system for buffer aware adaptive packet scheduling in a multiuser wireless system, the computer system comprising software modules for executing instructions to carry out the following:
employing a scheduler for scheduling packets in a multiuser wireless system that is responsive to both channel and buffer conditions in the multiuser wireless system, the scheduler capable of being generalized with existing metrics such as user rate or weighted rate;
using channel conditions to select candidate users which are those users whose transmission rates satisfy a certain condition for attaining a maximum of throughput deduction; and
using buffer conditions for scheduling decisions among all the candidate users and the users with largest queue backlog among the candidate users being scheduled to provide improved performance.

11. The computer system of claim 10, wherein the scheduler comprises a buffer aware adaptive BAA scheduler including, first step where a candidate user set is formed, based on either a user rate (MT metric) or a weighted rate (PF metric) supported by its channel condition, and in a second step a user with a largest queue backlog is selected from the candidate user set.

12. The computer system of claim 10, wherein the scheduler comprises a BAA scheduling procedure with a user rate (MT) metric comprising:
i) obtaining as R* a maximum rate of user rate with a system configured parameter α to find all the users with an instantaneous rate Rᵢ(t)≧αR* and form a candidate user set [symbol] _{α}; and
ii) from the user set [symbol] _{α}, selecting a user with a largest queue backlog size to transmit.

13. The computer system of claim 10, wherein the scheduler comprises a buffer aware adaptive scheduler for an orthogonal frequency division multiplexing system implemented as follows:
for each time slot t
Initializations, [symbol] ᵢ=Ø;
for the subchannel b=1, . . . , B;
given the rate for subchannel b, R_{i,b}(t), i=1, . . . , n, b=1, . . . , B, and queue backlog Qᵢ(t), apply the BAA (MT-BAA or PF-BAA) scheduling procedure to determine the user to be scheduled on subchannel n and assuming that the scheduled user is k, update [symbol] ₖ= [symbol] ₖ∪{b};
for user i=1, . . . , n, transmit data for user i along its allocated subchannels in [symbol] ᵢ.

14. The computer system of claim 10, wherein the scheduler comprises a generalized buffer aware adaptive scheduler comprising:
i) forming a candidate user set U_{α} for users with its metric in a region R defined by a function F(M1) of a first matrix M1, and possibly some other system configured parameters, i.e., U_{α}={i|M₁(i)εR_{F(M}_{₁}₎, where M₁(i) denotes the metric of the user; and
ii) selecting a user from the candidate user set to transmit that which maximizes a second metric M₂, i.e., k=arg max_{iεUa}M₂(i).

15. The computer system of claim 10, wherein the scheduler comprises a generalized 2-step scheduler procedure with two metrics such as forming a candidate user set with one metric and scheduling a user from the candidate user set using another metric, denoting M₁ and M₂ as a metric in first and second steps respectively, said metrics being a function of one of a function rate, average rate, queue backlog.

16. The computer system of claim 15, wherein the first metric M₁ can be Rᵢ(t) as in MT-BAA or Rᵢ(t)/uᵢ as in PF-BAA procedure and the second metric M₂ can be the production of rate and queue backlog, i.e., Rᵢ(t)Qᵢ(t) and instead of selecting a user from the candidate user set with the largest queue backlog size, the scheduler selects the one with the largest queue value.

17. The computer system of claim 15, wherein the first metric M₁ can be Rᵢ(t)Qᵢ(t), i.e., the candidate user set being formed for the user with Rᵢ(t)Qᵢ(t)≧αRᵢ(t)Qᵢ(t).

18. The computer system of claim 15, wherein the second metric can be a delay of the earliest arrived packet to be scheduled in the user buffer, i.e., the scheduler selects the user from the candidate user set formed in the first step with the largest delay of the earliest arrived packet in its buffer.
